(19) United States
(12) Patent Application Publication
(10) Pub. No.: US 2026/0106999 A1
(43) Pub. Date: Apr. 16, 2026

(54) SIGNALING SCHEME FOR TRANSFORM BLOCK PARTITION TYPES AND MULTI REFERENCE LINE SELECTION INDICES

(71) Applicant: Tencent America LLC, Palo Alto, CA (US)

(72) Inventors: Jayasingam ADHURAN, Palo Alto, CA (US); Liang ZHAO, Palo Alto, CA (US); Tianqi LIU, Palo Alto, CA (US); Madhu PERINGASSERY KRISHNAN, Palo Alto, CA (US); Ting-Lan LIN, Palo Alto, CA (US); Shan LIU, Palo Alto, CA (US)

(21) Appl. No.: 19/207,261

(22) Filed: May 13, 2025

Related U.S. Application Data
(60) Provisional application No. 63/708,106, filed on Oct. 16, 2024.

(51) Int. Cl. H04N 19/176; H04N 19/119; H04N 19/91

(52) U.S. Cl. CPC H04N 19/176; H04N 19/119; H04N 19/91

(57) ABSTRACT

The various implementations described herein include methods and systems for coding video. In one aspect, a method includes receiving a video bitstream including a current frame. The method includes partitioning the current frame according to a set of partitioning parameters to identify a plurality of blocks including a current block. The method includes when the current block has a first size, selecting a first transform partition from a first group of transform partitions as a transform partition for the current block, and when the current block has a second size, selecting a second transform partition from a second group of transform partitions as the transform partition for the current block. The method includes partitioning the current block into a set of transform blocks using the transform partition for the current block, and reconstructing the current block by reconstructing the set of transform blocks.

### RELATED APPLICATIONS

This application claims priority to U.S. Provisional Patent Application No. 63/708,106, entitled “Improved Signaling Scheme for Transform Block Partition Types and Multi Reference Line Selection Indices,” filed Oct. 16, 2024, which is hereby incorporated by reference in its entirety.

### TECHNICAL FIELD

The disclosed embodiments relate generally to video coding, including but not limited to systems and methods for using and signaling of transform block partitions.

### BACKGROUND

Digital video is supported by a variety of electronic devices, such as digital televisions, laptop or desktop computers, tablet computers, digital cameras, digital recording devices, digital media players, video gaming consoles, smart phones, video teleconferencing devices, video streaming devices, etc. The electronic devices transmit and receive or otherwise communicate digital video data across a communication network, and/or store the digital video data on a storage device. Due to a limited bandwidth capacity of the communication network and limited memory resources of the storage device, video coding may be used to compress the video data according to one or more video coding standards before it is communicated or stored. The video coding can be performed by hardware and/or software on an electronic/client device or a server providing a cloud service.

Video coding generally utilizes prediction methods (e.g., inter-prediction, intra-prediction, or the like) that take advantage of redundancy inherent in the video data. Video coding aims to compress video data into a form that uses a lower bit rate, while avoiding or minimizing degradations to video quality. Multiple video codec standards have been developed. For example, High-Efficiency Video Coding (HEVC/H.265) is a video compression standard designed as part of the MPEG-H project. ITU-T and ISO/IEC published the HEVC/H.265 standard in 2013 (version 1), 2014 (version 2), 2015 (version 3), and 2016 (version 4). Versatile Video Coding (VVC/H.266) is a video compression standard intended as a successor to HEVC. ITU-T and ISO/IEC published the VVC/H.266 standard in 2020 (version 1) and 2022 (version 2). AOMedia Video 1 (AV1) is an open video coding format designed as an alternative to HEVC. On Jan. 8, 2019, a validated version 1.0.0 with Errata 1 of the specification was released.

### SUMMARY

The present disclosure describes, amongst other things, a set of methods for video (image) compression, more specifically related to applying a transform block partition to partition a current block into a set of blocks. In some embodiments, a respective transform partition is selected from a group of transform partitions as a transform partition for the current block according to a size of the current block (e.g., block area and/or aspect ratio). In some embodiments, the current block is reconstructed by reconstructing the set of transform blocks using respective reference line indices signaling of transform block partitions. In some embodiments, coded block size groups are determined separately for the coded block sizes with mutually exclusive cases of the horizontal and vertical transform partitions, as well as for the coded block sizes with the conjunctions of the horizontal and vertical transform partitions. In this way, signal overhead may be reduced, a memory size that is needed to store to store context information may be reduced, and coding gain efficiency may be improved due to the reduced signaling.

In accordance with some embodiments, a method of video decoding includes (i) receiving a video bitstream comprising a plurality of frames, including a current frame; (ii) partitioning the current frame in accordance with a set of partitioning parameters to identify a plurality of blocks including a current block; (iii) when the current block has a first size, selecting a first transform partition from a first group of transform partitions as a transform partition for the current block; (iv) when the current block has a second size, selecting a second transform partition from a second group of transform partitions as the transform partition for the current block, wherein the second group of transform partitions has a different size than the first group of transform partitions; (v) partitioning the current block into a set of transform blocks using the transform partition for the current block; and (vi) reconstructing the current block by reconstructing the set of transform blocks.

In accordance with some embodiments, a method of video encoding includes (i) receiving video data comprising a plurality of frames that includes a current frame; (ii) partitioning the current frame in accordance with a set of partitioning parameters to identify a plurality of blocks including a current block; (iii) when the current block has a first size, selecting a first transform partition from a first group of transform partitions as a transform partition for the current block; (iv) when the current block has a second size, selecting a second transform partition from a second group of transform partitions as the transform partition for the current block, wherein the second group of transform partitions has a different size than the first group of transform partitions; (v) partitioning the current block into a set of transform blocks using the transform partition for the current block; and (vi) encoding the current block by encoding the set of transform blocks.

In accordance with some embodiments, a method of processing visual media data includes (i) obtaining a source video sequence that comprises a plurality of frames and (ii) performing a conversion between the source video sequence and a video bitstream of visual media data according to a format rule. The video bitstream comprises a plurality of encoded blocks including a current block. The format rule specifies that (a) the current frame is to be partitioned in accordance with a set of partitioning parameters to identify a plurality of blocks including a current block; (b) when the current block has a first size, a first transform partition is to be selected from a first group of transform partitions as a transform partition for the current block; (c) when the current block has a second size, a second transform partition is to be selected from a second group of transform partitions as the transform partition for the current block, wherein the second group of transform partitions has a different size than the first group of transform partitions; (d) the current block is to be partitioned into a set of transform blocks using the transform partition for the current block; and (e) the current block is to be reconstructed by reconstructing the set of transform blocks.

In accordance with some embodiments, a method of video decoding includes (i) receiving a video bitstream comprising a plurality of blocks, including a current block; (ii) determining a reference line index for the current block; (iii) identifying a set of transform partition types for the current block based on the reference line index; (iv) partitioning the current block into a set of transform blocks using a transform partition from the set of transform partition types; and (v) reconstructing the current block by reconstructing the set of transform blocks.

In accordance with some embodiments, a method of video decoding includes (i) receiving a video bitstream comprising a plurality of frames, including a current frame; (ii) partitioning the current frame into a plurality of prediction blocks based one a set of partitioning parameters, the plurality of prediction blocks including a current block; (iii) partitioning the current block into a set of transform blocks based on a set of transform partitioning parameters; (iv) determining a reference line index for each transform block in the set of transform blocks; and (v) reconstructing the current block by reconstructing the set of transform blocks using the respective reference line indices.

In accordance with some embodiments, a computing system is provided, such as a streaming system, a server system, a personal computer system, or other electronic device. The computing system includes control circuitry and memory storing one or more sets of instructions. The one or more sets of instructions including instructions for performing any of the methods described herein. In some embodiments, the computing system includes an encoder component and a decoder component (e.g., a transcoder).

In accordance with some embodiments, a non-transitory computer-readable storage medium is provided. The non-transitory computer-readable storage medium stores one or more sets of instructions for execution by a computing system. The one or more sets of instructions including instructions for performing any of the methods described herein.

Thus, devices and systems are disclosed with methods for encoding and decoding video. Such methods, devices, and systems may complement or replace conventional methods, devices, and systems for video encoding/decoding.

The features and advantages described in the specification are not necessarily all-inclusive and, in particular, some additional features and advantages will be apparent to one of ordinary skill in the art in view of the drawings, specification, and claims provided in this disclosure. Moreover, it should be noted that the language used in the specification has been principally selected for readability and instructional purposes and has not necessarily been selected to delineate or circumscribe the subject matter described herein.

### BRIEF DESCRIPTION OF THE DRAWINGS

So that the present disclosure can be understood in greater detail, a more particular description can be had by reference to the features of various embodiments, some of which are illustrated in the appended drawings. The appended drawings, however, merely illustrate pertinent features of the present disclosure and are therefore not necessarily to be considered limiting, for the description can admit to other effective features as the person of skill in this art will appreciate upon reading this disclosure.

FIG. 1 is a block diagram illustrating an example communication system in accordance with some embodiments.

FIG. 2A is a block diagram illustrating example elements of an encoder component in accordance with some embodiments.

FIG. 2B is a block diagram illustrating example elements of a decoder component in accordance with some embodiments.

FIG. 3 is a block diagram illustrating an example server system in accordance with some embodiments.

FIG. 4A illustrates the computation of a prediction block in accordance with some embodiments.

FIG. 4B illustrates the computation of a residue block in accordance with some embodiments.

FIG. 4C illustrates the computation of a reconstructed block in accordance with some embodiments.

FIG. 5 shows a schematic illustration of an example subset of directional intra prediction modes in accordance with some embodiments.

FIG. 6 illustrates an example intra prediction scheme based on various reference lines in accordance with some embodiments

FIGS. 7A-7D illustrate example coding tree structures in accordance with some embodiments.

FIG. 8 illustrates an example syntax signaling flow chart, in accordance with some embodiments.

FIG. 9A illustrates an example video decoding process in accordance with some embodiments.

FIG. 9B illustrates an example video encoding process in accordance with some embodiments.

In accordance with common practice, the various features illustrated in the drawings are not necessarily drawn to scale, and like reference numerals can be used to denote like features throughout the specification and figures.

### DETAILED DESCRIPTION

The present disclosure describes signaling of transform block partitions and multi reference line selection indices.

Some embodiments include partitioning a current frame according to a set of partitioning parameters to identify a plurality of blocks including a current block. Some embodiments include selecting a respective transform partition, from a respective group of multiple groups of transform partitions, as a transform partition for the current block according to a size of the current block. Some embodiments include partitioning the current block into a set of transform blocks using the transform partition for the current block and reconstructing the current block by reconstructing the set of transform blocks. An advantage of a respective transform partition according to the size of the current block is that it can reduce signal overhead, reduce a memory size that is needed to store to store the context, and improve coding gain efficiency.

### Example Systems and Devices

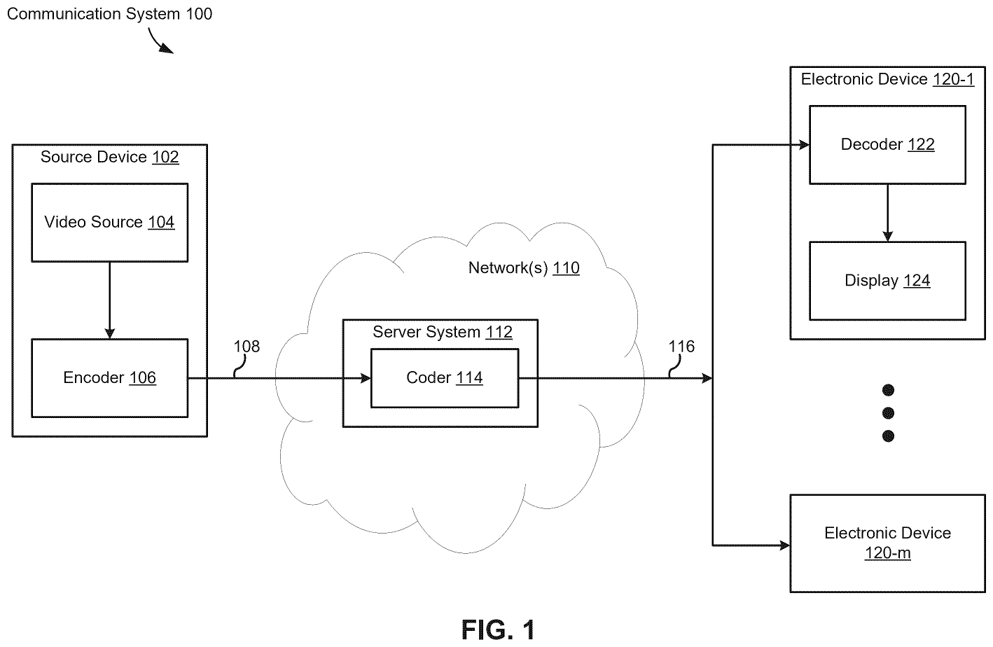

FIG. 1 is a block diagram illustrating a communication system 100 in accordance with some embodiments. The communication system 100 includes a source device 102 and a plurality of electronic devices 120 (e.g., electronic device 120-1 to electronic device 120-m) that are communicatively coupled to one another via one or more networks. In some embodiments, the communication system 100 is a streaming system, e.g., for use with video-enabled applications such as video conferencing applications, digital TV applications, and media storage and/or distribution applications.

The source device 102 includes a video source 104 (e.g., a camera component or media storage) and an encoder component 106. In some embodiments, the video source 104 is a digital camera (e.g., configured to create an uncompressed video sample stream). The encoder component 106 generates one or more encoded video bitstreams from the video stream. The video stream from the video source 104 may be high data volume as compared to the encoded video bitstream 108 generated by the encoder component 106. Because the encoded video bitstream 108 is lower data volume (less data) as compared to the video stream from the video source, the encoded video bitstream 108 requires less bandwidth to transmit and less storage space to store as compared to the video stream from the video source 104. In some embodiments, the source device 102 does not include the encoder component 106 (e.g., is configured to transmit uncompressed video to the network(s) 110).

The one or more networks 110 represents any number of networks that convey information between the source device 102, the server system 112, and/or the electronic devices 120, including for example wireline (wired) and/or wireless communication networks. The one or more networks 110 may exchange data in circuit-switched and/or packet-switched channels. Representative networks include telecommunications networks, local area networks, wide area networks and/or the Internet.

The one or more networks 110 include a server system 112 (e.g., a distributed/cloud computing system). In some embodiments, the server system 112 is, or includes, a streaming server (e.g., configured to store and/or distribute video content such as the encoded video stream from the source device 102). The server system 112 includes a coder component 114 (e.g., configured to encode and/or decode video data). In some embodiments, the coder component 114 includes an encoder component and/or a decoder component. In various embodiments, the coder component 114 is instantiated as hardware, software, or a combination thereof. In some embodiments, the coder component 114 is configured to decode the encoded video bitstream 108 and re-encode the video data using a different encoding standard and/or methodology to generate encoded video data 116. In some embodiments, the server system 112 is configured to generate multiple video formats and/or encodings from the encoded video bitstream 108. In some embodiments, the server system 112 functions as a Media-Aware Network Element (MANE). For example, the server system 112 may be configured to prune the encoded video bitstream 108 for tailoring potentially different bitstreams to one or more of the electronic devices 120. In some embodiments, a MANE is provided separate from the server system 112.

The electronic device 120-1 includes a decoder component 122 and a display 124. In some embodiments, the decoder component 122 is configured to decode the encoded video data 116 to generate an outgoing video stream that can be rendered on a display or other type of rendering device. In some embodiments, one or more of the electronic devices 120 does not include a display component (e.g., is communicatively coupled to an external display device and/or includes a media storage). In some embodiments, the electronic devices 120 are streaming clients. In some embodiments, the electronic devices 120 are configured to access the server system 112 to obtain the encoded video data 116.

The source device and/or the plurality of electronic devices 120 are sometimes referred to as “terminal devices” or “user devices.” In some embodiments, the source device 102 and/or one or more of the electronic devices 120 are instances of a server system, a personal computer, a portable device (e.g., a smartphone, tablet, or laptop), a wearable device, a video conferencing device, and/or other type of electronic device.

In example operation of the communication system 100, the source device 102 transmits the encoded video bitstream 108 to the server system 112. For example, the source device 102 may code a stream of pictures that are captured by the source device. The server system 112 receives the encoded video bitstream 108 and may decode and/or encode the encoded video bitstream 108 using the coder component 114. For example, the server system 112 may apply an encoding to the video data that is more optimal for network transmission and/or storage. The server system 112 may transmit the encoded video data 116 (e.g., one or more coded video bitstreams) to one or more of the electronic devices 120. Each electronic device 120 may decode the encoded video data 116 and optionally display the video pictures.

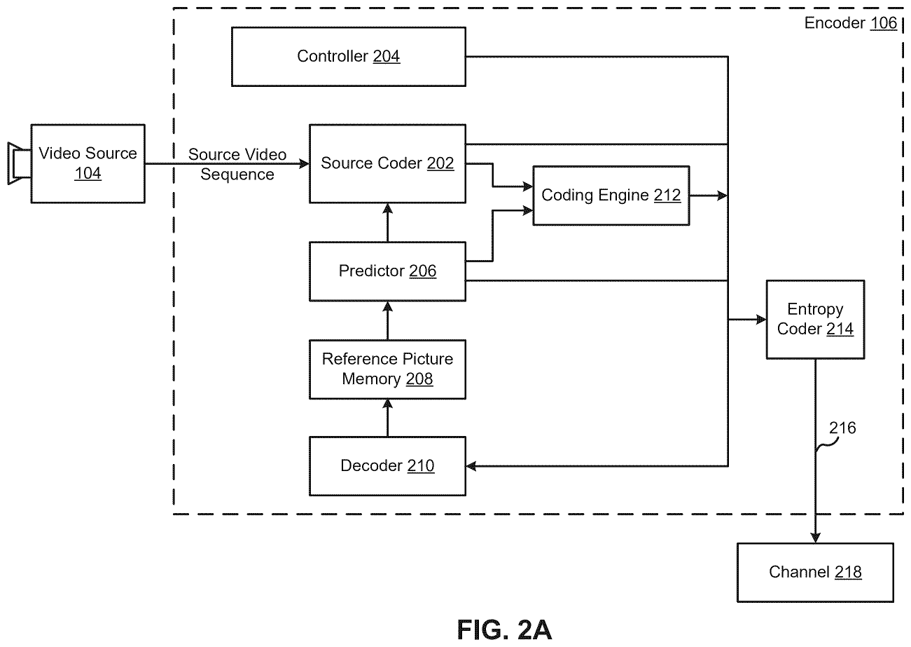

FIG. 2A is a block diagram illustrating example elements of the encoder component 106 in accordance with some embodiments. The encoder component 106 receives video data (e.g., a source video sequence) from the video source 104. In some embodiments, the encoder component includes a receiver (e.g., a transceiver) component configured to receive the source video sequence. In some embodiments, the encoder component 106 receives a video sequence from a remote video source (e.g., a video source that is a component of a different device than the encoder component 106). The video source 104 may provide the source video sequence in the form of a digital video sample stream that can be of any suitable bit depth (e.g., 8-bit, 10-bit, or 12-bit), any colorspace (e.g., BT.601 Y CrCB, or RGB), and any suitable sampling structure (e.g., Y CrCb 4:2:0 or Y CrCb 4:4:4). In some embodiments, the video source 104 is a storage device storing previously captured/prepared video. In some embodiments, the video source 104 is camera that captures local image information as a video sequence. Video data may be provided as a plurality of individual pictures that impart motion when viewed in sequence. The pictures themselves may be organized as a spatial array of pixels, where each pixel can include one or more samples depending on the sampling structure, color space, etc. in use. A person of ordinary skill in the art can readily understand the relationship between pixels and samples.

The encoder component 106 is configured to code and/or compress the pictures of the source video sequence into a coded video sequence 216 in real-time or under other time constraints as required by the application. In some embodiments, the encoder component 106 is configured to perform a conversion between the source video sequence and a bitstream of visual media data (e.g., a video bitstream). Enforcing appropriate coding speed is one function of a controller 204. In some embodiments, the controller 204 controls other functional units as described below and is functionally coupled to the other functional units. Parameters set by the controller 204 may include rate-control-related parameters (e.g., picture skip, quantizer, and/or lambda value of rate-distortion optimization techniques), picture size, group of pictures (GOP) layout, maximum motion vector search range, and so forth. A person of ordinary skill in the art can readily identify other functions of controller 204 as they may pertain to the encoder component 106 being optimized for a certain system design.

In some embodiments, the encoder component 106 is configured to operate in a coding loop. In a simplified example, the coding loop includes a source coder 202 (e.g., responsible for creating symbols, such as a symbol stream, based on an input picture to be coded and reference picture(s)), and a (local) decoder 210. The decoder 210 reconstructs the symbols to create the sample data in a similar manner as a (remote) decoder (when compression between symbols and coded video bitstream is lossless). The reconstructed sample stream (sample data) is input to the reference picture memory 208. As the decoding of a symbol stream leads to bit-exact results independent of decoder location (local or remote), the content in the reference picture memory 208 is also bit exact between the local encoder and remote encoder. In this way, the prediction part of an encoder interprets as reference picture samples the same sample values as a decoder would interpret when using prediction during decoding.

The operation of the decoder 210 can be the same as of a remote decoder, such as the decoder component 122, which is described in detail below in conjunction with FIG. 2B. Briefly referring to FIG. 2B, however, as symbols are available and encoding/decoding of symbols to a coded video sequence by an entropy coder 214 and the parser 254 can be lossless, the entropy decoding parts of the decoder component 122, including the buffer memory 252 and the parser 254 may not be fully implemented in the local decoder 210.

The decoder technology described herein, except the parsing/entropy decoding, may be to be present, in substantially identical functional form, in a corresponding encoder. For this reason, the disclosed subject matter focuses on decoder operation. Additionally, the description of encoder technologies can be abbreviated as they may be the inverse of the decoder technologies.

As part of its operation, the source coder 202 may perform motion compensated predictive coding, which codes an input frame predictively with reference to one or more previously-coded frames from the video sequence that were designated as reference frames. In this manner, the coding engine 212 codes differences between pixel blocks of an input frame and pixel blocks of reference frame(s) that may be selected as prediction reference(s) to the input frame. The controller 204 may manage coding operations of the source coder 202, including, for example, setting of parameters and subgroup parameters used for encoding the video data.

The decoder 210 decodes coded video data of frames that may be designated as reference frames, based on symbols created by the source coder 202. Operations of the coding engine 212 may advantageously be lossy processes. When the coded video data is decoded at a video decoder (not shown in FIG. 2A), the reconstructed video sequence may be a replica of the source video sequence with some errors. The decoder 210 replicates decoding processes that may be performed by a remote video decoder on reference frames and may cause reconstructed reference frames to be stored in the reference picture memory 208. In this manner, the encoder component 106 stores copies of reconstructed reference frames locally that have common content as the reconstructed reference frames that will be obtained by a remote video decoder (absent transmission errors).

The predictor 206 may perform prediction searches for the coding engine 212. That is, for a new frame to be coded, the predictor 206 may search the reference picture memory 208 for sample data (as candidate reference pixel blocks) or certain metadata such as reference picture motion vectors, block shapes, and so on, that may serve as an appropriate prediction reference for the new pictures. The predictor 206 may operate on a sample block-by-pixel block basis to find appropriate prediction references. As determined by search results obtained by the predictor 206, an input picture may have prediction references drawn from multiple reference pictures stored in the reference picture memory 208.

Output of all aforementioned functional units may be subjected to entropy coding in the entropy coder 214. The entropy coder 214 translates the symbols as generated by the various functional units into a coded video sequence, by losslessly compressing the symbols according to technologies known to a person of ordinary skill in the art (e.g., Huffman coding, variable length coding, and/or arithmetic coding).

In some embodiments, an output of the entropy coder 214 is coupled to a transmitter. The transmitter may be configured to buffer the coded video sequence(s) as created by the entropy coder 214 to prepare them for transmission via a communication channel 218, which may be a hardware/software link to a storage device which would store the encoded video data. The transmitter may be configured to merge coded video data from the source coder 202 with other data to be transmitted, for example, coded audio data and/or ancillary data streams (sources not shown). In some embodiments, the transmitter may transmit additional data with the encoded video. The source coder 202 may include such data as part of the coded video sequence. Additional data may comprise temporal/spatial/SNR enhancement layers, other forms of redundant data such as redundant pictures and slices, Supplementary Enhancement Information (SEI) messages, Visual Usability Information (VUI) parameter set fragments, and the like.

The controller 204 may manage operation of the encoder component 106. During coding, the controller 204 may assign to each coded picture a certain coded picture type, which may affect the coding techniques that are applied to the respective picture. For example, pictures may be assigned as an Intra Picture (I picture), a Predictive Picture (P picture), or a Bi-directionally Predictive Picture (B Picture). An Intra Picture may be coded and decoded without using any other frame in the sequence as a source of prediction. Some video codecs allow for different types of Intra pictures, including, for example Independent Decoder Refresh (IDR) Pictures. A person of ordinary skill in the art is aware of those variants of I pictures and their respective applications and features, and therefore they are not repeated here. A Predictive picture may be coded and decoded using intra prediction or inter prediction using at most one motion vector and reference index to predict the sample values of each block. A Bi-directionally Predictive Picture may be coded and decoded using intra prediction or inter prediction using at most two motion vectors and reference indices to predict the sample values of each block. Similarly, multiple-predictive pictures can use more than two reference pictures and associated metadata for the reconstruction of a single block.

Source pictures commonly may be subdivided spatially into a plurality of sample blocks (for example, blocks of 4×4, 8×8, 4×8, or 16×16 samples each) and coded on a block-by-block basis. Blocks may be coded predictively with reference to other (already coded) blocks as determined by the coding assignment applied to the blocks' respective pictures. For example, blocks of I pictures may be coded non-predictively or they may be coded predictively with reference to already coded blocks of the same picture (spatial prediction or intra prediction). Pixel blocks of P pictures may be coded non-predictively, via spatial prediction or via temporal prediction with reference to one previously coded reference pictures. Blocks of B pictures may be coded non-predictively, via spatial prediction or via temporal prediction with reference to one or two previously coded reference pictures.

A video may be captured as a plurality of source pictures (video pictures) in a temporal sequence. Intra-picture prediction (often abbreviated to intra prediction) makes use of spatial correlation in a given picture, and inter-picture prediction makes uses of the (temporal or other) correlation between the pictures. In an example, a specific picture under encoding/decoding, which is referred to as a current picture, is partitioned into blocks. When a block in the current picture is similar to a reference block in a previously coded and still buffered reference picture in the video, the block in the current picture can be coded by a vector that is referred to as a motion vector. The motion vector points to the reference block in the reference picture, and can have a third dimension identifying the reference picture, in case multiple reference pictures are in use.

The encoder component 106 may perform coding operations according to a predetermined video coding technology or standard, such as any described herein. In its operation, the encoder component 106 may perform various compression operations, including predictive coding operations that exploit temporal and spatial redundancies in the input video sequence. The coded video data, therefore, may conform to a syntax specified by the video coding technology or standard being used.

FIG. 2B is a block diagram illustrating example elements of the decoder component 122 in accordance with some embodiments. The decoder component 122 in FIG. 2B is coupled to the channel 218 and the display 124. In some embodiments, the decoder component 122 includes a transmitter coupled to the loop filter 256 and configured to transmit data to the display 124 (e.g., via a wired or wireless connection).

In some embodiments, the decoder component 122 includes a receiver coupled to the channel 218 and configured to receive data from the channel 218 (e.g., via a wired or wireless connection). The receiver may be configured to receive one or more coded video sequences to be decoded by the decoder component 122. In some embodiments, the decoding of each coded video sequence is independent from other coded video sequences. Each coded video sequence may be received from the channel 218, which may be a hardware/software link to a storage device which stores the encoded video data. The receiver may receive the encoded video data with other data, for example, coded audio data and/or ancillary data streams, that may be forwarded to their respective using entities (not depicted). The receiver may separate the coded video sequence from the other data. In some embodiments, the receiver receives additional (redundant) data with the encoded video. The additional data may be included as part of the coded video sequence(s). The additional data may be used by the decoder component 122 to decode the data and/or to more accurately reconstruct the original video data. Additional data can be in the form of, e.g., temporal, spatial, or SNR enhancement layers, redundant slices, redundant pictures, forward error correction codes, and so on.

In accordance with some embodiments, the decoder component 122 includes a buffer memory 252, a parser 254 (also sometimes referred to as an entropy decoder), a scaler/inverse transform unit 258, an intra picture prediction unit 262, a motion compensation prediction unit 260, an aggregator 268, the loop filter unit 256, a reference picture memory 266, and a current picture memory 264. In some embodiments, the decoder component 122 is implemented as an integrated circuit, a series of integrated circuits, and/or other electronic circuitry. The decoder component 122 may be implemented at least in part in software.

The buffer memory 252 is coupled in between the channel 218 and the parser 254 (e.g., to combat network jitter). In some embodiments, the buffer memory 252 is separate from the decoder component 122. In some embodiments, a separate buffer memory is provided between the output of the channel 218 and the decoder component 122. In some embodiments, a separate buffer memory is provided outside of the decoder component 122 (e.g., to combat network jitter) in addition to the buffer memory 252 inside the decoder component 122 (e.g., which is configured to handle playout timing). When receiving data from a store/forward device of sufficient bandwidth and controllability, or from an isosynchronous network, the buffer memory 252 may not be needed, or can be small. For use on best effort packet networks such as the Internet, the buffer memory 252 may be required, can be comparatively large and/or of adaptive size, and may at least partially be implemented in an operating system or similar elements outside of the decoder component 122.

The parser 254 is configured to reconstruct symbols 270 from the coded video sequence. The symbols may include, for example, information used to manage operation of the decoder component 122, and/or information to control a rendering device such as the display 124. The control information for the rendering device(s) may be in the form of, for example, Supplementary Enhancement Information (SEI) messages or Video Usability Information (VUI) parameter set fragments (not depicted). The parser 254 parses (entropy-decodes) the coded video sequence. The coding of the coded video sequence can be in accordance with a video coding technology or standard, and can follow principles well known to a person skilled in the art, including variable length coding, Huffman coding, arithmetic coding with or without context sensitivity, and so forth. The parser 254 may extract from the coded video sequence, a set of subgroup parameters for at least one of the subgroups of pixels in the video decoder, based upon at least one parameter corresponding to the group. Subgroups can include Groups of Pictures (GOPs), pictures, tiles, slices, macroblocks, Coding Units (CUs), blocks, Transform Units (TUs), Prediction Units (PUs) and so forth. The parser 254 may also extract, from the coded video sequence, information such as transform coefficients, quantizer parameter values, motion vectors, and so forth.

Reconstruction of the symbols 270 can involve multiple different units depending on the type of the coded video picture or parts thereof (such as: inter and intra picture, inter and intra block), and other factors. Which units are involved, and how they are involved, can be controlled by the subgroup control information that was parsed from the coded video sequence by the parser 254. The flow of such subgroup control information between the parser 254 and the multiple units below is not depicted for clarity.

The decoder component 122 can be conceptually subdivided into a number of functional units, and in some implementations, these units interact closely with each other and can, at least partly, be integrated into each other. However, for clarity, the conceptual subdivision of the functional units is maintained herein.

The scaler/inverse transform unit 258 receives quantized transform coefficients as well as control information (such as which transform to use, block size, quantization factor, and/or quantization scaling matrices) as symbol(s) 270 from the parser 254. The scaler/inverse transform unit 258 can output blocks including sample values that can be input into the aggregator 268. In some cases, the output samples of the scaler/inverse transform unit 258 pertain to an intra coded block; that is: a block that is not using predictive information from previously reconstructed pictures, but can use predictive information from previously reconstructed parts of the current picture. Such predictive information can be provided by the intra picture prediction unit 262. The intra picture prediction unit 262 may generate a block of the same size and shape as the block under reconstruction, using surrounding already-reconstructed information fetched from the current (partly reconstructed) picture from the current picture memory 264. The aggregator 268 may add, on a per sample basis, the prediction information the intra picture prediction unit 262 has generated to the output sample information as provided by the scaler/inverse transform unit 258.

In other cases, the output samples of the scaler/inverse transform unit 258 pertain to an inter coded, and potentially motion-compensated, block. In such cases, the motion compensation prediction unit 260 can access the reference picture memory 266 to fetch samples used for prediction. After motion compensating the fetched samples in accordance with the symbols 270 pertaining to the block, these samples can be added by the aggregator 268 to the output of the scaler/inverse transform unit 258 (in this case called the residual samples or residual signal) so to generate output sample information. The addresses within the reference picture memory 266, from which the motion compensation prediction unit 260 fetches prediction samples, may be controlled by motion vectors. The motion vectors may be available to the motion compensation prediction unit 260 in the form of symbols 270 that can have, for example, X, Y, and reference picture components. Motion compensation may also include interpolation of sample values as fetched from the reference picture memory 266, e.g., when sub-sample exact motion vectors are in use, motion vector prediction mechanisms.

The output samples of the aggregator 268 can be subject to various loop filtering techniques in the loop filter unit 256. Video compression technologies can include in-loop filter technologies that are controlled by parameters included in the coded video bitstream and made available to the loop filter unit 256 as symbols 270 from the parser 254, but can also be responsive to meta-information obtained during the decoding of previous (in decoding order) parts of the coded picture or coded video sequence, as well as responsive to previously reconstructed and loop-filtered sample values. The output of the loop filter unit 256 can be a sample stream that can be output to a render device such as the display 124, as well as stored in the reference picture memory 266 for use in future inter-picture prediction.

Certain coded pictures, once reconstructed, can be used as reference pictures for future prediction. Once a coded picture is reconstructed and the coded picture has been identified as a reference picture (by, for example, parser 254), the current reference picture can become part of the reference picture memory 266, and a fresh current picture memory can be reallocated before commencing the reconstruction of the following coded picture.

The decoder component 122 may perform decoding operations according to a predetermined video compression technology that may be documented in a standard, such as any of the standards described herein. The coded video sequence may conform to a syntax specified by the video compression technology or standard being used, in the sense that it adheres to the syntax of the video compression technology or standard, as specified in the video compression technology document or standard and specifically in the profiles document therein. Also, for compliance with some video compression technologies or standards, the complexity of the coded video sequence may be within bounds as defined by the level of the video compression technology or standard. In some cases, levels restrict the maximum picture size, maximum frame rate, maximum reconstruction sample rate (measured in, for example megasamples per second), maximum reference picture size, and so on. Limits set by levels can, in some cases, be further restricted through Hypothetical Reference Decoder (HRD) specifications and metadata for HRD buffer management signaled in the coded video sequence.

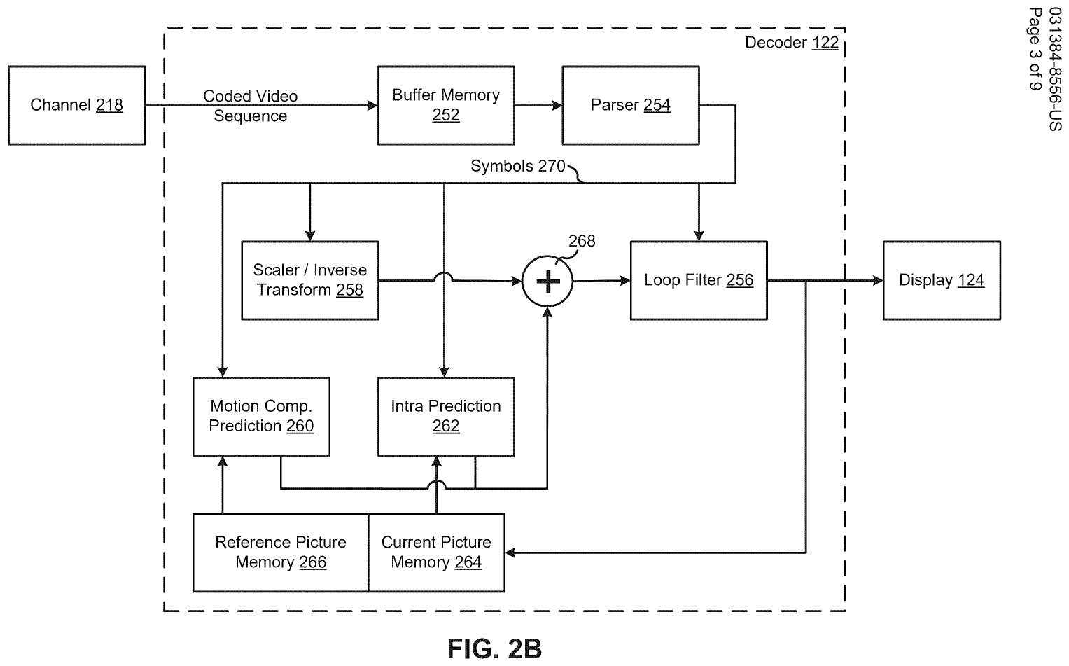

FIG. 3 is a block diagram illustrating the server system 112 in accordance with some embodiments. The server system 112 includes control circuitry 302, one or more network interfaces 304, a memory 314, a user interface 306, and one or more communication buses 312 for interconnecting these components. In some embodiments, the control circuitry 302 includes one or more processors (e.g., a CPU, GPU, and/or DPU). In some embodiments, the control circuitry includes field-programmable gate array(s), hardware accelerators, and/or integrated circuit(s) (e.g., an application-specific integrated circuit).

The network interface(s) 304 may be configured to interface with one or more communication networks (e.g., wireless, wireline, and/or optical networks). The communication networks can be local, wide-area, metropolitan, vehicular and industrial, real-time, delay-tolerant, and so on. Examples of communication networks include local area networks such as Ethernet, wireless LANs, cellular networks to include GSM, 3G, 4G, 5G, LTE and the like, TV wireline or wireless wide area digital networks to include cable TV, satellite TV, and terrestrial broadcast TV, vehicular and industrial to include CANBus, and so forth. Such communication can be unidirectional, receive only (e.g., broadcast TV), unidirectional send-only (e.g., CANbus to certain CANbus devices), or bi-directional (e.g., to other computer systems using local or wide area digital networks). Such communication can include communication to one or more cloud computing networks.

The user interface 306 includes one or more output devices 308 and/or one or more input devices 310. The input device(s) 310 may include one or more of: a keyboard, a mouse, a trackpad, a touch screen, a data-glove, a joystick, a microphone, a scanner, a camera, or the like. The output device(s) 308 may include one or more of: an audio output device (e.g., a speaker), a visual output device (e.g., a display or monitor), or the like.

The memory 314 may include high-speed random-access memory (such as DRAM, SRAM, DDR RAM, and/or other random access solid-state memory devices) and/or non-volatile memory (such as one or more magnetic disk storage devices, optical disk storage devices, flash memory devices, and/or other non-volatile solid-state storage devices). The memory 314 optionally includes one or more storage devices remotely located from the control circuitry 302. The memory 314, or, alternatively, the non-volatile solid-state memory device(s) within the memory 314, includes a non-transitory computer-readable storage medium. In some embodiments, the memory 314, or the non-transitory computer-readable storage medium of the memory 314, stores the following programs, modules, instructions, and data structures, or a subset or superset thereof:
an operating system 316 that includes procedures for handling various basic system services and for performing hardware-dependent tasks;
a network communication module 318 that is used for connecting the server system 112 to other computing devices via the one or more network interfaces 304 (e.g., via wired and/or wireless connections);
a coding module 320 for performing various functions with respect to encoding and/or decoding data, such as video data. In some embodiments, the coding module 320 is an instance of the coder component 114. The coding module 320 including, but not limited to, one or more of:
   a decoding module 322 for performing various functions with respect to decoding encoded data, such as those described previously with respect to the decoder component 122; and
   an encoding module 340 for performing various functions with respect to encoding data, such as those described previously with respect to the encoder component 106; and
a picture memory 352 for storing pictures and picture data, e.g., for use with the coding module 320. In some embodiments, the picture memory 352 includes one or more of: the reference picture memory 208, the buffer memory 252, the current picture memory 264, and the reference picture memory 266.

In some embodiments, the decoding module 322 includes a parsing module 324 (e.g., configured to perform the various functions described previously with respect to the parser 254), a transform module 326 (e.g., configured to perform the various functions described previously with respect to the scalar/inverse transform unit 258), a prediction module 328 (e.g., configured to perform the various functions described previously with respect to the motion compensation prediction unit 260 and/or the intra picture prediction unit 262), and a filter module 330 (e.g., configured to perform the various functions described previously with respect to the loop filter 256).

In some embodiments, the encoding module 340 includes a code module 342 (e.g., configured to perform the various functions described previously with respect to the source coder 202 and/or the coding engine 212) and a prediction module 344 (e.g., configured to perform the various functions described previously with respect to the predictor 206). In some embodiments, the decoding module 322 and/or the encoding module 340 include a subset of the modules shown in FIG. 3. For example, a shared prediction module is used by both the decoding module 322 and the encoding module 340.

Each of the above identified modules stored in the memory 314 corresponds to a set of instructions for performing a function described herein. The above identified modules (e.g., sets of instructions) need not be implemented as separate software programs, procedures, or modules, and thus various subsets of these modules may be combined or otherwise re-arranged in various embodiments. For example, the coding module 320 optionally does not include separate decoding and encoding modules, but rather uses a same set of modules for performing both sets of functions. In some embodiments, the memory 314 stores a subset of the modules and data structures identified above. In some embodiments, the memory 314 stores additional modules and data structures not described above.

Although FIG. 3 illustrates the server system 112 in accordance with some embodiments, FIG. 3 is intended more as a functional description of the various features that may be present in one or more server systems rather than a structural schematic of the embodiments described herein. In practice, items shown separately could be combined and some items could be separated. For example, some items shown separately in FIG. 3 could be implemented on single servers and single items could be implemented by one or more servers. The actual number of servers used to implement the server system 112, and how features are allocated among them, will vary from one implementation to another and, optionally, depends in part on the amount of data traffic that the server system handles during peak usage periods as well as during average usage periods.

### Example Coding Techniques

The coding processes and techniques described below may be performed at the devices and systems described above (e.g., the source device 102, the server system 112, and/or the electronic device 120). According to some embodiments, methods for signaling transform block partition types for intra and/or inter coded blocks are described below. The methods and systems disclosed herein can be used in the future video codes and existing codecs or extensions of those codecs as mentioned in the background section.

In the following, a block may correspond to a coding tree block, the largest coding block, a pre-defined fixed block size, a coding block, a prediction block, a residual block, or a transform block. An intra coded block may correspond to a block that is coded using an intra prediction mode, or a combined intra-inter prediction mode. An intra mode list may correspond to a list of most probable intra prediction modes for the current block.

In some embodiments, multiple reference line selection for intra prediction uses farther (non-adjacent) reference lines for intra prediction. An encoding component may decide, and signal, which reference line is used to generate the intra predictor. At the decoder side, after parsing the reference line index, the intra prediction of current block will be generated by using the reconstructed samples in the specified reference line.

In the following, a transform may correspond to a primary transform, a secondary transform, a separable transform, and/or a non-separable transform. A transform block partition type may correspond to partitions used to divide the coded block into one or multiple transform blocks. A transform partition may correspond to none-split partition, a square partition, a horizontal binary partition, a vertical binary partition, a three-way horizontal partition and a three-way vertical partition. A transform group size may correspond to grouped coding block sizes that are used to derive the context for signaling of the transform partition type.

In the following, a tree-type may correspond to a shared partition tree between luma and chroma blocks or single tree used by luma or chroma blocks. In the following, a flag may correspond to a single bit or multiple bits that carry information about a particular selection.

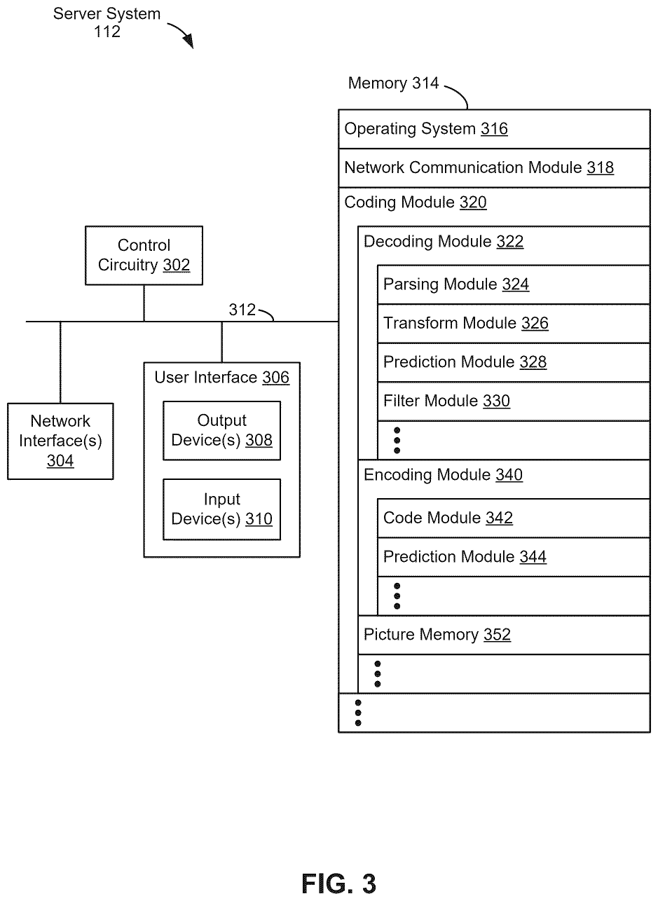

FIGS. 4A-4C illustrate an overview of a quantization and subsequent dequantization process. FIG. 4A illustrates the computation of a prediction block in accordance with some embodiments. In the example of FIG. 4A, an intra prediction is performed on a current block 402 to generate a predicted block 404. The current block 402 includes a set of samples (e.g., pixel blocks) and the prediction block 404 includes a set of predictions that correspond to the set of samples. FIG. 4B illustrates the computation of a residue block in accordance with some embodiments. As shown in FIG. 4B, the prediction block 404 is subtracted from the current block 402 to generate a residue block 406 that includes a set of residues. For example, respective differences are calculated between each sample and the corresponding prediction. FIG. 4C illustrates the computation of a reconstructed block in accordance with some embodiments. As shown in FIG. 4C, the residue block 406 undergoes one or more transformations and quantization to generate a set of residual coefficients. The set of residual coefficients may be transmitted from an encoder component to a decoder component. The set of residual coefficients undergo a reverse quantization and reverse transformation to generate a reconstructed residue block 408. The reconstructed residue block 408 is combined with the predicted block 404 (e.g., reconstructed residues of the reconstructed residue block 408 are added to predictions of the prediction block 404) to generate a reconstructed block 410 corresponding to the current block 402.

Notably, the transforms performed during decoding of the video bitstream may be inverses of the transformed performed during encoding of the video bitstream, and are sometimes referred to as “inverse transforms”. For simplicity, the transformations described herein may be referred to as “transforms” whether performed during encoding or decoding.

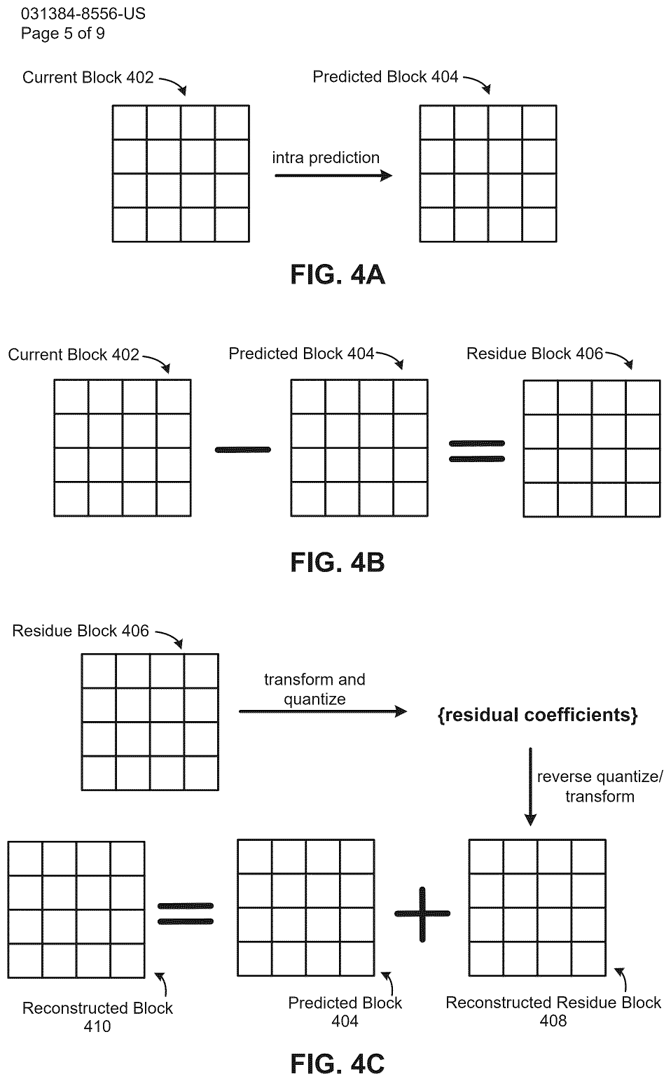

FIG. 5 depicts a subset of predictor directions of various directional intra prediction modes. For directional intra prediction, some approaches support 8 directional modes corresponding to angles from 45 to 207 degrees. To exploit more varieties of spatial redundancy in directional textures, directional intra modes may be extended to an angle set with finer granularity. For example, the 8 angles may be denoted as nominal angles. The 8 nominal angles, named V_PRED, H_PRED, D45_PRED, D135_PRED, D113_PRED, D157_PRED, D203_PRED, and D67_PRED, are shown in FIG. 5. For each nominal angle, there may be 7 finer angles for a total of 56 directional angles. A prediction angle may be described by a nominal intra angle plus an angle delta. Thus, there are eight nominal directional intra prediction modes, each of which has an associated set of angle delta offsets ranging from −3 to +3. FIG. 5 shows the eight nominal modes (solid arrows) with an example of the set of angle delta offsets around the D67_PRED nominal mode (dotted arrows). The point 502 where the arrows converge represents the sample being predicted. The arrows represent the direction from which neighboring samples are used to predict the sample at point 502. For example, D45_PRED indicates that sample is predicted from a neighboring sample or samples to the upper right, at a 45-degree angle from the horizontal direction. Similarly, D203_PRED indicates that sample is predicted from a neighboring sample or samples to the lower left of sample, in a 22.5-degree angle from the horizontal direction.

In some embodiments, intra prediction of samples in a coding block or prediction block may be based on one of a set of reference lines. Instead of using a nearest neighboring line (e.g., an adjacent reference line), multiple reference lines may be provided as options for selection for intra prediction. Such intra prediction implementations may be referred to as Multiple Reference Line Selection (MRLS). In some embodiments, an encoder decides and signals which reference line of a plurality of reference lines is used to generate the intra predictor. At the decoder side, after parsing the reference line index, the intra prediction of current intra-prediction block can be generated by identifying the reconstructed reference samples by looking up the specified reference line according to the intra prediction mode (such the directional, non-directional, and other intra-prediction modes). In some embodiments, a reference line index may be signaled in the coding block level and only one of the multiple reference lines may be selected and used for intra prediction of one coding block. In some embodiments, more than one reference lines may be selected together for intra-prediction. For example, the more than one reference lines may be combined, averaged, interpolated or in any other manner, with or without weight, to generate the prediction.

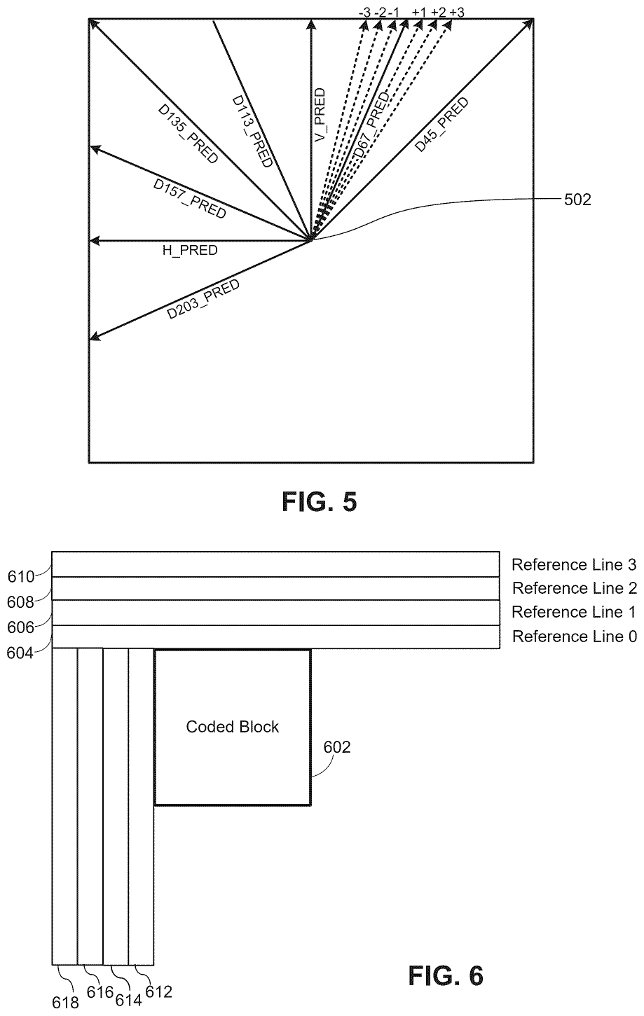

FIG. 6 illustrates an example of four reference-line MRLS, in accordance with some embodiments. An intra-coding block 602 may be predicted based on one or more of the four horizontal reference lines 604, 606, 608, and 610 and four vertical reference lines 612, 614, 616, and 618. Among these reference lines, reference line 604 and reference line 612 are the immediate neighboring reference lines (e.g., adjacent reference lines). In some embodiments, the reference lines may be indexed according to their distance from the coding block. For example, reference lines 604 and 612 may be referred to as zero reference line whereas the other reference lines may be referred to as non-zero reference lines. In some embodiments, reference lines 606 and 614 may be known as first reference lines, reference lines 608 and 616 may be known as second reference lines; and reference lines 610 and 618 may be known as third reference lines.

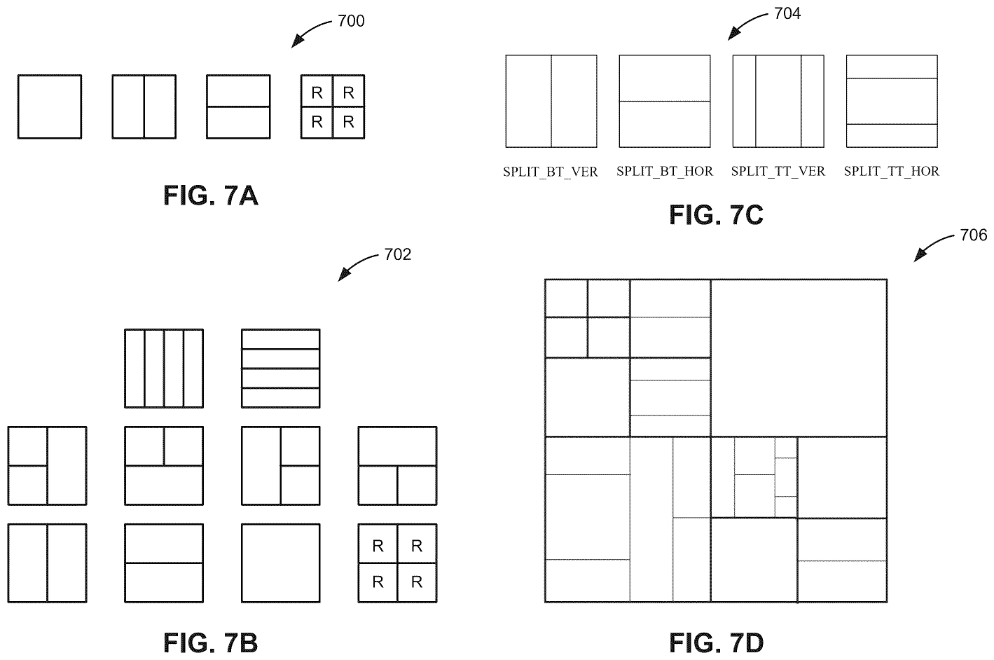

FIGS. 7A-7D illustrate example coding tree structures in accordance with some embodiments. As shown in a first coding tree structure (700) in FIG. 7A, some coding approaches (e.g., VP9) use a 4-way partition tree starting from a 64×64 level down to a 4×4 level, with some additional restrictions for blocks 8×8. In FIG. 7A, partitions designated as R can be referred to as recursive in that the same partition tree is repeated at a lower scale until the lowest 4×4 level is reached. As shown in a second coding tree structure (702) in FIG. 7B, some coding approaches (e.g., AV1) expand the partition tree to a 10-way structure and increase the largest size (e.g., referred to as a superblock in VP9/AV1 parlance) to start from 128×128. The second coding tree structure includes 4:1/1:4 rectangular partitions that are not in the first coding tree structure. The partition types with 3 sub-partitions in the second row of FIG. 7B are referred to as T-type partitions. In addition to a coding block size, coding tree depth can be defined to indicate the splitting depth from the root note.

As an example, a CTU may be split into CUs by using a quad-tree structure denoted as a coding tree to adapt to various local characteristics, such as in HEVC. In some embodiments, the decision on whether to code a picture area using inter-picture (temporal) or intra-picture (spatial) prediction is made at the CU level. Each CU can be further split into one, two, or four PUs according to the PU splitting type. Inside one PU, the same prediction process is applied, and the relevant information is transmitted to the decoder on a PU basis. After obtaining the residual block by applying the prediction process based on the PU splitting type, a CU can be partitioned into TUs according to another quad-tree structure like the coding tree for the CU.

A quad-tree with nested multi-type tree using binary and ternary splits segmentation structure, such as in VVC, may replace the concepts of multiple partition unit types, e.g., it removes the separation of the CU, PU, and TU concepts except as needed for CUs that have a size too large for the maximum transform length, and supports more flexibility for CU partition shapes. In the coding tree structure, a CU can have either a square or rectangular shape. ACTU is first partitioned by a quaternary tree (also referred to as quad-tree) structure. The quaternary tree leaf nodes can be further partitioned by a multi-type tree structure. As shown in a third coding tree structure (704) in FIG. 7C, the multi-type tree structure includes four splitting types. The multi-type tree leaf nodes are called CUs, and unless the CU is too large for the maximum transform length, this segmentation is used for prediction and transform processing without any further partitioning. This means that, in most cases, the CU, PU, and TU have the same block size in the quad-tree with nested multi-type tree coding block structure. An example of block partitions for one CTU (706) is shown in FIG. 7D, which illustrates an example quadtree with nested multi-type tree coding block structure.

In accordance with some embodiments, transform partitioning is indicated by the flag “do_partition flag=1.” In some systems, if a current block can support both horizontal and vertical split (e.g., illustrated in FIGS. 7A-7D), the transform partition type is signaled using five symbols. However, in these systems, if the current block can support just one of horizontal or vertical split, the transform partition type is still signaled using five symbols. This leads to excessive signaling overhead and coding complexity. In accordance with some embodiments, the redundancy caused by use of five symbols to indicate a two-symbol event (e.g., 2-way partition or 3-way partition) is removed. For example, the horizontal or vertical split is signaled using two symbols.

Table 1 below illustrates an example transform group size look-up table that has been modified to support the two-symbol signaling, in accordance with some embodiments. In some embodiments BLOCK_4X8 and BLOCK_8X4 are applicable for two-way partition and they are implicitly derived.

TABLE 1
Modified Transform Group Size Look-up Table

| | txfm_2or3_way_parti- | txfm_4way_parti- |
|---|---|---|
| Block sizes | tion_type | tion_type |
| BLOCK_8X8, | | 0 |
| BLOCK_8X16, | | 1 |
| BLOCK_16X8, | | 2 |
| BLOCK_16X16, | | 3 |
| BLOCK_16X32, | | 4 |
| BLOCK_32X16, | | 5 |
| BLOCK_32X32, | | 6 |
| BLOCK_32X64, | | 7 |
| BLOCK_64X32, | | 8 |
| BLOCK_64X64, | | 9 |
| BLOCK_64X128, | | 9 |
| BLOCK_128X64, | | 9 |
| BLOCK_128X128, | | 9 |
| BLOCK_128X256, | | 9 |
| BLOCK_256X128, | | 9 |
| BLOCK_256X256, | | 9 |
| BLOCK_4X16, | 0 | |
| BLOCK_16X4, | 1 | |
| BLOCK_8X32, | | 10 |
| BLOCK_32X8, | | 11 |
| BLOCK_16X64, | | 12 |
| BLOCK_64X16, | | 13 |
| BLOCK_4X32, | 0 | |
| BLOCK_32X4, | 1 | |
| BLOCK_8X64, | | 10 |
| BLOCK_64X8, | | 11 |
| BLOCK_4X64, | 0 | |
| BLOCK_64X4, | 1 | |

Signaling of transform partition types using two symbols as described herein, can improve coding efficiency. Table 2 below illustrates the improvements to encoding and decoding based on simulations performed using current designs (e.g., AVM design v8.0) with various video data (e.g., AOM Common Test Conditions).

TABLE 2
Simulation Results

| | | | | YUV- | | |
|---|---|---|---|---|---|---|
| | Y-PSNR | U-PSNR | V-PSNR | PSNR | Enc-time | Dec-time |
| Random Access | −0.01% | 0.10% | 0.17% | 0.00% | 96% | 95% |
| Low Delay | −0.04% | −0.17% | −0.06% | −0.04% | 98% | 94% |

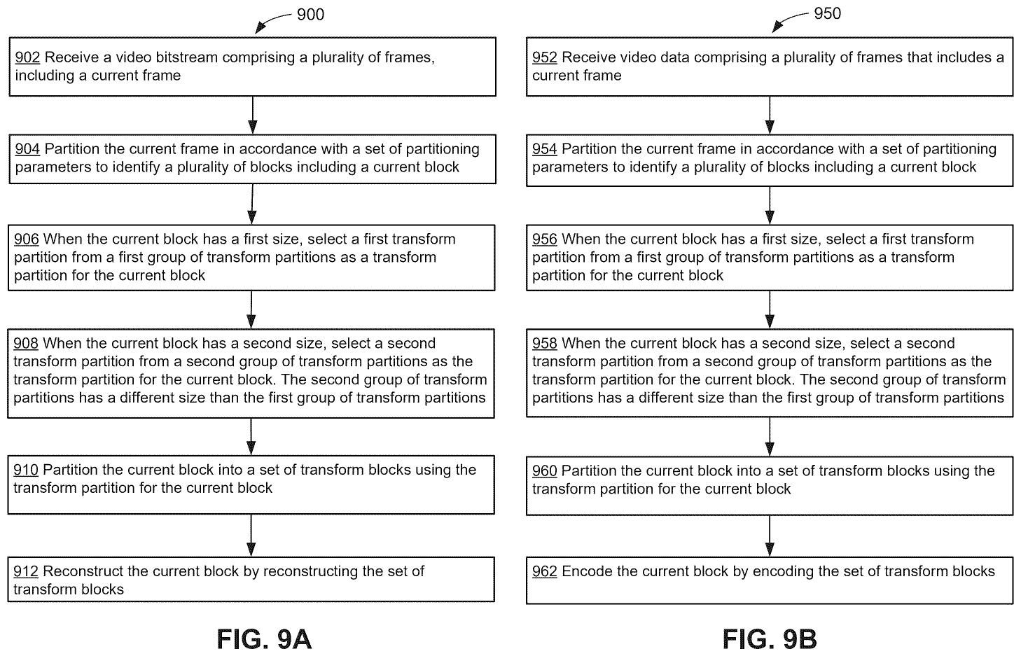

FIG. 9A is a flow diagram illustrating a method 900 of decoding video in accordance with some embodiments. The method 900 may be performed at a computing system (e.g., the server system 112, the source device 102, or the electronic device 120) having control circuitry and memory storing instructions for execution by the control circuitry. In some embodiments, the method 900 is performed by executing instructions stored in the memory (e.g., the memory 314) of the computing system.

The system receives (902) a video bitstream (e.g., a coded video sequence) comprising a plurality of frames, including a current frame. The system partitions (904) the current frame in accordance with a set of partitioning parameters to identify a plurality of blocks including a current block. When the current block has a first size, the system selects (906) a first transform partition from a first group of transform partitions as a transform partition for the current block. When the current block has a second size, the system selects (908) a second transform partition from a second group of transform partitions as the transform partition for the current block. The second group of transform partitions has a different size than the first group of transform partitions. The system partitions (910) the current block into a set of transform blocks using the transform partition for the current block. The system reconstructs (912) the current block by reconstructing the set of transform blocks. In this way, coded block size groups may be determined separately for the coded block sizes with mutually exclusive cases of the horizontal and vertical transform partitions, as well as for the coded block sizes with the conjunctions of the horizontal and vertical transform partitions.

In some embodiments, for an intra coded block, the selection or signaling of transform partition types may depend on the reference line index in Multi Line Reference Selection (MLRS) and the selected partition type is cither explicitly signaled or implicitly derived. In some embodiments, the context for signaling the transform partition types may depend on the reference line index in MLRS. In some embodiments, the context for signaling the transform partition types may depend on whether the reference line index in MLRS is greater than or equal to one threshold or not. In some embodiments, the threshold is set to 1.

In some embodiments, the reference line index in MLRS may be used to determine whether a specific transform partition type or partition types of an intra coded block can be allowed or not. In some embodiments, the intra coded block may be located on a shared, luma or chroma tree. In some embodiments, transform partition types is derived as none-split partition when the MLRS index is greater than one threshold. In some embodiments, the threshold is set 1. In some embodiments, transform partition types other than three-way horizontal partition and three-way vertical partition can be selected when the MLRS index is greater than one threshold. In one example, the threshold is set 1. In some embodiments, previously coded transform partition types can be used to determine if a transform partition is coded or not.

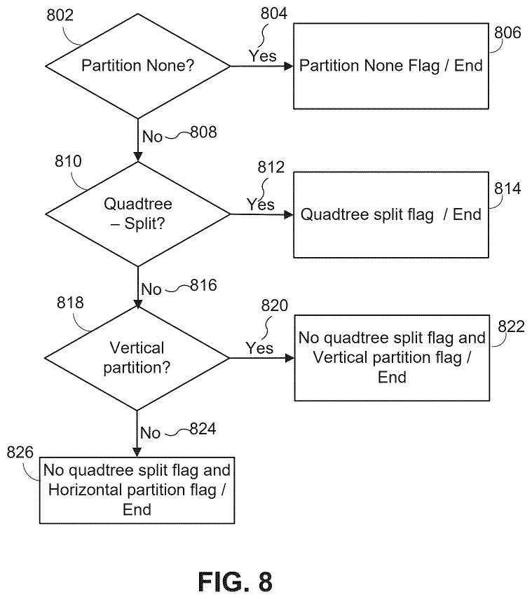

In some embodiments, one flag is firstly signaled to indicate whether partition_none is used or not. If not, another flag is signaled to indicate whether quadtrec_partition_split is used or not. If yes, no other flags are signaled. Otherwise, another flag is further signaled to indicate whether the split is vertical direction or horizontal direction. For example, FIG. 8 illustrates a syntax signaling flow chart, in accordance with some embodiments. In some embodiments, a flag 802 is signaled to indicate whether partition_none is used or not. If yes (step 804), no other flag is signaled and the process ends (step 806). If not (step 808), another flag 810 is signaled to indicate whether quadtree_partition_split is used or not. If quadtree_partition_split is used (step 812), the process ends (step 814). If not (step 816), another flag 818 is further signaled to indicate whether the split is in the vertical direction. If yes (step 820), the process ends (step 822), if not (step 824), the split is the horizontal direction (step 826).

In some embodiments, any previously coded information may be used for ordering the list of transform partition types of intra and/or inter coded blocks. In some embodiments, the list may be populated in a descending order based on the probability of transform partition types. In some embodiments, the probability of the transform partition types may be hard coded and kept as fixed relative order. In some embodiments, the transform partition types of neighboring blocks transform partition types can be used to re-order the transform partition type list for current block. In some embodiments, the probability of transform partition types may be updated during encoding and decoding based on any previously coded information or any information that is known to both encoder and decoder.

In some embodiments, the coded block size groups are determined separately for the coded block sizes with mutually exclusive cases of the horizontal and vertical transform partitions, as well as for the coded block sizes with the conjunctions of the horizontal and vertical transform partitions. The selected partition type is either explicitly signaled or implicitly derived. The coded block size group may be used to determine the context for signaling the transform block partition types.

In some embodiments, the selected transform partition type may be coded using M symbols or N symbols. M is not equal to N. In some embodiments, M is set to 5, and N is set to 2. In some embodiments, a look-up table is used to map the coding block size with transform group sizes that support both vertical and horizontal transform partitions. In some embodiments, a look-up table is used to map the coding block size with transform group sizes that support vertical only or horizontal only transform partitions. In some embodiments, transform partitions representing both vertical and horizontal partition shall be encoded with M symbols. In some embodiments, transform partitions representing vertical only or horizontal only partition shall be encoded with N symbols.

In some embodiments, for partition types of the transform blocks, any previously coded information may be used for ordering the list of probability values. For example, the list may be populated in a descending order based on the probability of transform partition types.

In some embodiments, the probability of transform partition types may be hard coded and kept as fixed relative order. In some embodiments, the probability of transform partition types may be updated during encoding and decoding based on any previously coded information or any information that is known to both encoder and decoder.

In some embodiments, an MLRS index is selected and signaled at the transform block level and/or the coded block level. An intra predicted block may correspond to one or multiple transform blocks. Each transform block within the coded block is allowed to have different MLRS indices. In some embodiments, for each transform block, the MLRS index is signaled separately. In some embodiments, for each transform block, the MLRS index can be explicitly signaled or implicitly derived at the encoder and the decoder.

In some embodiments, the selection of reference line index at the transform block level may depend on the reference line index at the coded block level. In some embodiments, if the reference line index at the coded block level indicates the adjacent reference line is used, then reference line index for each transform block is set to the reference line index of the coded block level. In some embodiments, if the reference line index at the coded block level indicates the non-adjacent reference is used, then one flag is signaled at each transform block to indicate whether it is the same as the code block level reference line index. If not, the reference line index at that transform block is set to the index for adjacent reference line.

In some embodiments, MLRS index of an intra predicted coding block and/or a threshold may be used to signal the MLRS index of the transform block. In some embodiments, if the MLRS index of an intra predicted coding block is the same as the MLRS index of a corresponding transform block, MLRS index of that transform block is derived at the encoder and the decoder. In some embodiments, the difference between the MLRS index of an intra predicted coding block is signaled. In some embodiments, the threshold is a predefined value, such as 1 or 2.

In some embodiments, for MLRS indices of the transform blocks, any previously coded information may be used for ordering the list of probability values. For example, the list may be populated in a descending order based on the probability of MLRS indices. In some embodiments, the probability of MLRS indices of the transform blocks may be hard coded and kept as fixed relative order. In another example, the probability of MLRS indices of the transform blocks may be updated during encoding and decoding based on any previously coded information or any information that is known to both encoder and decoder

FIG. 9B is a flow diagram illustrating a method 950 of encoding video in accordance with some embodiments. The method 950 may be performed at a computing system (e.g., the server system 112, the source device 102, or the electronic device 120) having control circuitry and memory storing instructions for execution by the control circuitry. In some embodiments, the method 950 is performed by executing instructions stored in the memory (e.g., the memory 314) of the computing system. In some embodiments, the method 950 is performed by a same system as the method 900 described above.

The system receives (952) video data (e.g., a source video sequence) comprising a plurality of frames that includes a current frame. The system partitions (954) the current frame in accordance with a set of partitioning parameters to identify a plurality of blocks including a current block. When the current block has a first size, the system selects (956) a first transform partition from a first group of transform partitions as a transform partition for the current block. When the current block has a second size, the system selects (958) a second transform partition from a second group of transform partitions as the transform partition for the current block. When second group of transform partitions has a different size than the first group of transform partitions. The system partitions (960) the current block into a set of transform blocks using the transform partition for the current block. The system encodes (962) the current block by encoding the set of transform blocks. As described previously, the encoding process may mirror the decoding processes described herein (e.g., transform block partitioning and MLRS indexing). For brevity, those details are not repeated here.

Although FIGS. 9A and 9B illustrate a number of logical stages in a particular order, stages which are not order dependent may be reordered and other stages may be combined or broken out. Some reordering or other groupings not specifically mentioned will be apparent to those of ordinary skill in the art, so the ordering and groupings presented herein are not exhaustive. Moreover, it should be recognized that the stages could be implemented in hardware, firmware, software, or any combination thereof.

Turning now to some example embodiments.

(A1) In one aspect, some embodiments include a method (e.g., the method 900) of video decoding. In some embodiments, the method is performed at a computing system (e.g., the server system 112) having memory and control circuitry. In some embodiments, the method is performed at a coding module (e.g., the coding module 320). In some embodiments, the method is performed at a source coding component (e.g., the source coder 202), a coding engine (e.g., the coding engine 212), and/or an entropy coder (e.g., the entropy coder 214). The method includes (i) receiving a video bitstream (e.g., a coded video sequence) comprising a plurality of frames, including a current frame; (ii) partitioning the current frame in accordance with a set of partitioning parameters to identify a plurality of blocks including a current block; (iii) when the current block has a first size, selecting a first transform partition from a first group of transform partitions as a transform partition for the current block; (iv) when the current block has a second size, selecting a second transform partition from a second group of transform partitions as the transform partition for the current block, wherein the second group of transform partitions has a different size than the first group of transform partitions; (v) partitioning the current block into a set of transform blocks using the transform partition for the current block; and (vi) reconstructing the current block by reconstructing the set of transform blocks. For example, the coded block size groups may be determined separately for the coded block sizes with mutually exclusive cases of the horizontal and vertical transform partitions, as well as for the coded block sizes with the conjunctions of the horizontal and vertical transform partitions. In some embodiments, the plurality of blocks is a plurality of prediction blocks. In some embodiments, the size of the current block is determined and based on the size of the current block, a first or second transform group is selected. As described previously, a transform applied during decoding may be the inverse of a transform applied during encoding.

(A2) In some embodiments of A1, horizontal and vertical partitions are allowed for the first size, and wherein the first group of transform partitions includes both horizontal and vertical partitions.

(A3) In some embodiments of A1, only one of horizontal and vertical partitions are allowed for the first size, and wherein the second group of transform partitions includes only one of horizontal and vertical partitions.

(A4) In some embodiments of any of A1-A3, the method further includes entropy decoding an indicator from the video bitstream, the indicator indicating a transform index; and wherein the transform partition for the current block is selected in accordance with the transform index. For example, the selected partition type may be either explicitly signaled or implicitly derived.

(A5) In some embodiments of A4, when the current block has the first size, the indicator is entropy encoded using a first context based on a size of the first group of transform partitions; and when the current block has the second size, the indicator is entropy encoded using a second context based on a size of the second group of transform partitions. For example, the coded block size group may be used to determine the context for signaling the transform block partition types.

(A6) In some embodiments of A4 or A5, when the current block has the first size, the indicator is signaled with M symbols, M being a positive integer; and when the current block has the second size, the indicator is signaled with N symbols, N being a positive integer that is greater than M. For example, the selected transform partition type may be coded using M symbols or N symbols. M is not equal to N. As a particular example, M may be equal to 5 (or 4, 6, or other number), and N may be equal to 2 (or 1, 3, or other number).

(A7) In some embodiments of A6, transforms in the first group of transform partitions are signaled with the M symbols, and transforms in the second group of transform partitions are signaled with the N symbols. For example, transform partitions representing both vertical and horizontal partition may be encoded with M symbols and transform partitions representing vertical only or horizontal only partition may be encoded with N symbols.

(A8) In some embodiments of A4, when the current block has the first size, the first transform partition is selected using the indicator and a first look-up table; and when the current block has the second size, the second transform partition is selected using the indicator and a second look-up table. For example, a first look-up table is used to map the coding block size with transform group sizes that support both vertical and horizontal transform partitions. In this example, a second look-up table is used to map the coding block size with transform group sizes that support vertical only or horizontal only transform partitions.

(A9) In some embodiments of any of A1-A8, the first group of transform partitions is populated in a descending order based on probabilities of respective transform partitions in the first group. For example, for partition types of the transform blocks, any previously coded information may be used for ordering the list of probability values. As an example, the list may be populated in a descending order based on the probability of transform partition types.

(A10) In some embodiments of A9, the probabilities of respective transform partitions in the first group are fixed. For example, the probability of transform partition types may be hard coded and kept as fixed relative order.

(A11) In some embodiments of A9, the probabilities of respective transform partitions in the first group are updated based on previously-decoded information. For example, the probability of transform partition types may be updated during encoding and decoding based on any previously coded information or any information that is known to both encoder and decoder.

(A12) In some embodiments of any of A1-A11, a block size of the current block comprises one or more of: a block area, a block height, a block width, and a block aspect ratio.

(B1) In another aspect, some embodiments include a method (e.g., the method 950) of video encoding. In some embodiments, the method is performed at a computing system (e.g., the server system 112) having memory and control circuitry. In some embodiments, the method is performed at a coding module (e.g., the coding module 320). The method includes: (i) receiving video data (e.g., a source video sequence) comprising a plurality of frames that includes a current frame; (ii) partitioning the current frame in accordance with a set of partitioning parameters to identify a plurality of blocks including a current block; (iii) when the current block has a first size, selecting a first transform partition from a first group of transform partitions as a transform partition for the current block; (iv) when the current block has a second size, selecting a second transform partition from a second group of transform partitions as the transform partition for the current block, wherein the second group of transform partitions has a different size than the first group of transform partitions; (v) partitioning the current block into a set of transform blocks using the transform partition for the current block; and (vi) encoding the current block by encoding the set of transform blocks.

(B2) In some embodiments of B1, horizontal and vertical partitions are allowed for the first size, and the first group of transform partitions includes both horizontal and vertical partitions.

(B3) In some embodiments of B1, only one of horizontal and vertical partitions are allowed for the first size, and the second group of transform partitions includes only one of horizontal and vertical partitions.

(B4) In some embodiments of any of B1-B3, the method further includes entropy encoding an indicator for the video bitstream, the indicator indicating a transform index for the transform partition for the current block.

(C1) In another aspect, some embodiments include a method of visual media data processing. In some embodiments, the method is performed at a computing system (e.g., the server system 112) having memory and control circuitry. In some embodiments, the method is performed at a coding module (e.g., the coding module 320). The method includes: (i) obtaining a source video sequence that comprises a plurality of frames; and (ii) performing a conversion between the source video sequence and a video bitstream of visual media data according to a format rule. The video bitstream comprises a plurality of encoded blocks including a current block. The format rule specifies that (a) the current frame is to be partitioned in accordance with a set of partitioning parameters to identify a plurality of blocks including a current block; (b) when the current block has a first size, a first transform partition is to be selected from a first group of transform partitions as a transform partition for the current block; (c) when the current block has a second size, a second transform partition is to be selected from a second group of transform partitions as the transform partition for the current block, wherein the second group of transform partitions has a different size than the first group of transform partitions; (d) the current block is to be partitioned into a set of transform blocks using the transform partition for the current block; and (c) the current block is to be reconstructed by reconstructing the set of transform blocks.

(C2) In some embodiments of C1, horizontal and vertical partitions are allowed for the first size, and the first group of transform partitions includes both horizontal and vertical partitions.

(C3) In some embodiments of C1, only one of horizontal and vertical partitions are allowed for the first size, and wherein the second group of transform partitions includes only one of horizontal and vertical partitions.

(C4) In some embodiments of any of C1-C3, the video bitstream comprises an indicator indicating a transform index for the transform partition for the current block.

(D1) In another aspect, some embodiments include a method of video decoding. In some embodiments, the method is performed at a computing system (e.g., the server system 112) having memory and control circuitry. In some embodiments, the method is performed at a coding module (e.g., the coding module 320). In some embodiments, the method is performed at a source coding component (e.g., the source coder 202), a coding engine (e.g., the coding engine 212), and/or an entropy coder (e.g., the entropy coder 214). The method includes (i) receiving a video bitstream (e.g., a coded video sequence) comprising a plurality of blocks, including a current block; (ii) determining a reference line index for the current block; (iii) identifying a set of transform partition types for the current block based on the reference line index; (iv) partitioning the current block into a set of transform blocks using a transform partition from the set of transform partition types; and (v) reconstructing the current block by reconstructing the set of transform blocks. For example, for an intra coded block, the selection or signaling of transform partition types may depend on the reference line index in MLRS and the selected partition type may be either explicitly signaled or implicitly derived.

(D2) In some embodiments of D1, the method further includes parsing an indicator from the video bitstream, the indicator indicating the transform partition.

(D3) In some embodiments of D1 or D2, the current block is an intra mode block. For example, the intra coded block may be located on a shared, luma or chroma tree.

(D4) In some embodiments of any of D1-D3, the method further includes entropy decoding an indicator from the video bitstream, the indicator indicating the set of transform partition types, wherein the indicator is entropy decoded using a context that is based on the reference line index. For example, the context for signaling the transform partition types may depend on the reference line index in Multi Line Reference Selection. As an example, the context for signaling the transform partition types may depend on whether the reference line index is greater than or equal to a threshold or not. In various examples, the threshold may be 0, 1, or 2.

(D5) In some embodiments of any of D1-D4, identifying the set of transform partition types comprises determining whether a partition type is allowed for the current block based on the reference line index. For example, the reference line index in MLRS may be used to determine whether a specific transform partition type or partition types of an intra coded block can be allowed or not. As an example, transform partition types may be derived as none-split partition when the MLRS index is greater than a threshold (e.g., a threshold of 0, 1, or other value). In another example, transform partition types other than three-way horizontal partition and three-way vertical partition can be selected when the MLRS index is greater than a threshold (e.g., a threshold of 0, 1, or other value).

(D6) In some embodiments of any of D1-D5, identifying the set of transform partition types comprises determining whether a partition type is allowed for the current block based on a set of previously-decoded transform partition types. For example, previously coded transform partition types can be used to determine if a transform partition is coded or not. As an example, a flag is firstly signaled to indicate whether partition_none is used or not. If not, another flag is signaled to indicate whether quadtree_partition_split is used or not. If yes, no other flags are signaled. Otherwise, another flag is further signaled to indicate whether the split is vertical direction or horizontal direction.

(D7) In some embodiments of any of D1-D6, the set of transform partition types are sorted based on previously-decoded information. For example, any previously coded information may be used for ordering the list of transform partition types of intra and/or inter coded blocks. As an example, the list may be populated in a descending order based on the probability of transform partition types. The probability of the transform partition types may be hard coded and kept as fixed relative order. As another example, the transform partition types of neighboring blocks transform partition types may be used to re-order the transform partition type list for current block. As another example, the probability of transform partition types may be updated during encoding and decoding based on any previously-coded information or any information that is known to both encoder and decoder.

(E1) In another aspect, some embodiments include a method of video decoding. In some embodiments, the method is performed at a computing system (e.g., the server system 112) having memory and control circuitry. In some embodiments, the method is performed at a coding module (e.g., the coding module 320). In some embodiments, the method is performed at a source coding component (e.g., the source coder 202), a coding engine (e.g., the coding engine 212), and/or an entropy coder (e.g., the entropy coder 214). The method includes (i) receiving a video bitstream (e.g., a coded video sequence) comprising a plurality of frames, including a current frame; (ii) partitioning the current frame into a plurality of prediction blocks based one a set of partitioning parameters, the plurality of prediction blocks including a current block; (iii) partitioning the current block into a set of transform blocks based on a set of transform partitioning parameters; (iv) determining a reference line index for each transform block in the set of transform blocks; and (v) reconstructing the current block by reconstructing the set of transform blocks using the respective reference line indices. For example, a MLRS index may be signaled and selected at the transform block level and/or the coded block level. As an example, an intra predicted block may correspond to one or multiple transform blocks and each transform block within the coded block is allowed to have different Multi Line Reference Selection indices.

(E2) In some embodiments of E1, the respective reference line indices are signaled separately. For example, for each transform block, the MLRS index is signaled separately.

(E3) In some embodiments of E1 or E2, one or more of the respective reference line indices derived and not signaled in the video bitstream. For example, for each transform block, the MLRS index can be explicitly signaled or implicitly derived at the encoder and the decoder. In some embodiments, the selection of reference line index at the transform block level depends on the reference line index at the coded block level.

(E4) In some embodiments of any of E3, selection of a reference line index at a transform block level depends on a reference line index at the coded block level. For example, if the reference line index at the coded block level indicates the adjacent reference line is used, then reference line index for each transform block may be set to the reference line index of the coded block level. As another example, if the reference line index at the coded block level indicates the non-adjacent reference is used, then one flag may be signaled at each transform block to indicate whether it is the same as the code block level reference line index. If not, the reference line index at that transform block may be set to the index for adjacent reference line.

(E5) In some embodiments of any of E1-E4, selection of a reference line index at a transform block level depends on a reference line index at the coded block level and a threshold value. For example, a MLRS index of an intra predicted coding block and/or a threshold may be used to signal the MLRS index of the transform block. As an example, if the MLRS index of an intra predicted coding block is the same as the MLRS index of a corresponding transform block, MLRS index of that transform block is derived at the encoder and the decoder. In another example, the difference between the MLRS index of an intra predicted coding block and the transform block MLRS is signaled. As an example, the threshold may be a predefined value, such as 1 or 2.

In another aspect, some embodiments include a computing system (e.g., the server system 112) including control circuitry (e.g., the control circuitry 302) and memory (e.g., the memory 314) coupled to the control circuitry, the memory storing one or more sets of instructions configured to be executed by the control circuitry, the one or more sets of instructions including instructions for performing any of the methods described herein (e.g., A1-A12, B1-B4, C1-C4, D1-D7, and E1-E5 above).

In yet another aspect, some embodiments include a non-transitory computer-readable storage medium storing one or more sets of instructions for execution by control circuitry of a computing system, the one or more sets of instructions including instructions for performing any of the methods described herein (e.g., A1-A12, B1-B4, C1-C4, D1-D7, and E1-E5 above).

Unless otherwise specified, any of the syntax elements (e.g., indicators) described herein may be high-level syntax (HLS). As used herein, HLS is signaled at a level that is higher than a block level. For example, HLS may correspond to a sequence level, a frame level, a slice level, or a tile level. As another example, HLS elements may be signaled in a video parameter set (VPS), a sequence parameter set (SPS), a picture parameter set (PPS), an adaptation parameter set (APS), a slice header, a picture header, a tile header, and/or a CTU header.

It will be understood that, although the terms “first,” “second,” etc. may be used herein to describe various elements, these elements should not be limited by these terms. These terms are only used to distinguish one element from another. The terminology used herein is for the purpose of describing particular embodiments only and is not intended to be limiting of the claims. As used in the description of the embodiments and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “when” can be construed to mean “if” or “upon” or “in response to determining” or “in accordance with a determination” or “in response to detecting” that a stated condition precedent is true, depending on the context. Similarly, the phrase “if it is determined [that a stated condition precedent is true]” or “if [a stated condition precedent is true]” or “when [a stated condition precedent is true]” can be construed to mean “upon determining” or “in response to determining” or “in accordance with a determination” or “upon detecting” or “in response to detecting” that the stated condition precedent is true, depending on the context.

The foregoing description, for purposes of explanation, has been described with reference to specific embodiments. However, the illustrative discussions above are not intended to be exhaustive or limit the claims to the precise forms disclosed. Many modifications and variations are possible in view of the above teachings. The embodiments were chosen and described in order to best explain principles of operation and practical applications, to thereby enable others skilled in the art.

What is claimed is:

1. A method of video decoding performed at a computing system having memory and one or more processors, the method comprising:
receiving a video bitstream comprising a plurality of frames, including a current frame;
partitioning the current frame in accordance with a set of partitioning parameters to identify a plurality of blocks including a current block;
when the current block has a first size, selecting a first transform partition from a first group of transform partitions as a transform partition for the current block;
when the current block has a second size, selecting a second transform partition from a second group of transform partitions as the transform partition for the current block, wherein the second group of transform partitions has a different size than the first group of transform partitions;
partitioning the current block into a set of transform blocks using the transform partition for the current block; and
reconstructing the current block by reconstructing the set of transform blocks.

2. The method of claim 1, wherein horizontal and vertical partitions are allowed for the first size, and wherein the first group of transform partitions includes both horizontal and vertical partitions.

3. The method of claim 1, wherein only one of horizontal and vertical partitions are allowed for the first size, and wherein the second group of transform partitions includes only one of horizontal and vertical partitions.

4. The method of claim 1, further comprising entropy decoding an indicator from the video bitstream, the indicator indicating a transform index; and
wherein the transform partition for the current block is selected in accordance with the transform index.

5. The method of claim 4, wherein:
when the current block has the first size, the indicator is entropy encoded using a first context based on a size of the first group of transform partitions; and
when the current block has the second size, the indicator is entropy encoded using a second context based on a size of the second group of transform partitions.

6. The method of claim 4, wherein:
when the current block has the first size, the indicator is signaled with M symbols, M being a positive integer; and
when the current block has the second size, the indicator is signaled with N symbols, N being a positive integer that is greater than M.

7. The method of claim 6, wherein transforms in the first group of transform partitions are signaled with the M symbols, and wherein transforms in the second group of transform partitions are signaled with the N symbols.

8. The method of claim 4, wherein:
when the current block has the first size, the first transform partition is selected using the indicator and a first look-up table; and
when the current block has the second size, the second transform partition is selected using the indicator and a second look-up table.

9. The method of claim 1, wherein the first group of transform partitions is populated in a descending order based on probabilities of respective transform partitions in the first group.

10. The method of claim 9, wherein the probabilities of respective transform partitions in the first group are fixed.

11. The method of claim 9, wherein the probabilities of respective transform partitions in the first group are updated based on previously-decoded information.

12. The method of claim 1, wherein a block size of the current block comprises one or more of: a block area, a block height, a block width, and a block aspect ratio.

13. A method of video encoding performed at a computing system having memory and one or more processors, the method comprising:
receiving video data comprising a plurality of frames that includes a current frame;
partitioning the current frame in accordance with a set of partitioning parameters to identify a plurality of blocks including a current block;
when the current block has a first size, selecting a first transform partition from a first group of transform partitions as a transform partition for the current block;
when the current block has a second size, selecting a second transform partition from a second group of transform partitions as the transform partition for the current block, wherein the second group of transform partitions has a different size than the first group of transform partitions;
partitioning the current block into a set of transform blocks using the transform partition for the current block; and
encoding the current block by encoding the set of transform blocks.

14. The method of claim 13, wherein horizontal and vertical partitions are allowed for the first size, and wherein the first group of transform partitions includes both horizontal and vertical partitions.

15. The method of claim 13, wherein only one of horizontal and vertical partitions are allowed for the first size, and wherein the second group of transform partitions includes only one of horizontal and vertical partitions.

16. The method of claim 13, further comprising entropy encoding an indicator for the video bitstream, the indicator indicating a transform index for the transform partition for the current block.

17. A method of processing visual media data, the method comprising:
obtaining a source video sequence that comprises a plurality of frames; and
performing a conversion between the source video sequence and a video bitstream of visual media data according to a format rule,
wherein the video bitstream comprises a plurality of encoded blocks including a current block; and
wherein the format rule specifies that:
the current frame is to be partitioned in accordance with a set of partitioning parameters to identify a plurality of blocks including a current block;
when the current block has a first size, a first transform partition is to be selected from a first group of transform partitions as a transform partition for the current block;
when the current block has a second size, a second transform partition is to be selected from a second group of transform partitions as the transform partition for the current block, wherein the second group of transform partitions has a different size than the first group of transform partitions;
the current block is to be partitioned into a set of transform blocks using the transform partition for the current block; and
the current block is to be reconstructed by reconstructing the set of transform blocks.

18. The method of claim 17, wherein horizontal and vertical partitions are allowed for the first size, and wherein the first group of transform partitions includes both horizontal and vertical partitions.

19. The method of claim 17, wherein only one of horizontal and vertical partitions are allowed for the first size, and wherein the second group of transform partitions includes only one of horizontal and vertical partitions.

20. The method of claim 17, wherein the video bitstream comprises an indicator indicating a transform index for the transform partition for the current block.
